(19) United States
(12) Patent Application Publication
(10) Pub. No.: US 2018/0157818 A1
(43) Pub. Date: Jun. 7, 2018

(54) PROCESSING APPARATUS, MOBILE DEVICE, AND NON-TRANSITORY COMPUTER READABLE MEDIUM STORING AUTHENTICATION REQUEST PROGRAM

(71) Applicant: FUJI XEROX CO., LTD., Tokyo (JP)

(72) Inventors: Naoya NOBUTANI, Kanagawa (JP); Masafumi ONO, Kanagawa (JP); Manabu HAYASHI, Kanagawa (JP); Kunitoshi YAMAMOTO, Kanagawa (JP); Toru SUZUKI, Kanagawa (JP)

(73) Assignee: FUJI XEROX CO., LTD., Tokyo (JP)

(21) Appl. No.: 15/729,679

(22) Filed: Oct. 11, 2017

(30) Foreign Application Priority Data
Dec. 7, 2016 (JP) 2016-237186

(51) Int. Cl. G06F 21/35; G06F 21/30; G06F 21/60; G06F 21/82

(52) U.S. Cl. CPC G06F 21/35; G06F 21/305; G06F 2221/2141; G06F 21/82; G06F 21/608

(57) ABSTRACT

A processing apparatus includes a process execution unit that executes a process according to a user instruction; a first communication unit that performs wireless communication with a mobile device which is moved to a predetermined communication area; an authentication processing unit that executes a user authentication process in a case where the first communication unit receives both information that the mobile device is in a process request mode and a user ID maintained by the mobile device through communication with the mobile device; and a process execution permission unit that permits the process execution unit to execute the necessary authentication process in a case where the reception user ID is recognized as a user ID possessed by the user who has the authority to cause the authentication processing unit to execute the necessary authentication process.

### CROSS-REFERENCE TO RELATED APPLICATIONS

This application is based on and claims priority under 35 USC 119 from Japanese Patent Application No. 2016-237186 filed Dec. 7, 2016.

### BACKGROUND

### (i) Technical Field

The present invention relates to a processing apparatus, a mobile device, and a non-transitory computer readable medium storing an authentication request program.

### (ii) Related Art

Generally, a printer, a multi-function machine, and the like, which are installed in an office or a store, stand in appointed places and are shared by people who exist in the places. Here, the multi-function machine is a device which has plural functions, including a function as the printer, and, for example, the multi-function machine is a device which combines a function as a copying machine, a function as a scanner, and the like.

The shared printer and the multi-function machine includes a device in which a user ID is registered such that the device is used by only an appointed user and which is set such that the device is used after checking a user who has use authority through a user authentication process. In a case where the user authentication process is performed, reduction in waiting time, which is apt to be extended for the user authentication process, of the user and reduction in troublesomeness of a user operation for user authentication are demanded.

### SUMMARY

According to an aspect of the invention, there is provided a processing apparatus including: a process execution unit that executes a process according to a user instruction; a first communication unit that performs wireless communication with a mobile device which is moved to a predetermined communication area; an authentication processing unit that, in a case where the first communication unit receives both information that the mobile device is in a process request mode, which requests to execute the process in the process execution unit and which is set and released by a user operation performed on the mobile device, and a user ID which is maintained by the mobile device through communication with the mobile device, executes a user authentication process of recognizing whether or not a user who has the reception user ID received by the first communication unit is a user who has authority to cause the process execution unit to execute at least part of necessary authentication process among processes which can be executed by the process execution unit; and a process execution permission unit that, in a case where the reception user ID is recognized as a user ID possessed by the user who has the authority to cause the authentication processing unit to execute the necessary authentication process, permits the process execution unit to execute the necessary authentication process.

### BRIEF DESCRIPTION OF THE DRAWINGS

Exemplary embodiment(s) of the present invention will be described in detail based on the following figures, wherein:

FIG. 1 is a diagram of a whole configuration of a printing system;

FIG. 2 is a diagram of a hardware configuration of a multi-function machine whose appearance is illustrated in FIG. 1;

FIG. 3 is a functional block diagram of the multi-function machine illustrated in FIG. 1;

FIG. 4 is a functional block diagram of a mobile device illustrated in FIG. 1;

FIG. 5 is a flowchart of a process setting program executed in the mobile device;

FIG. 6 is a diagram illustrating a multi-function machine ID setting screen;

FIG. 7 is a flowchart of a communication cut-off program activated in a case where execution of the process setting program ends;

FIG. 8 is a diagram illustrating a function setting screen;

FIG. 9 is a diagram illustrating a “copy” menu screen;

FIG. 10 is a flowchart illustrating a communication program;

FIG. 11 is a diagram illustrating an OK screen displayed in step S32 of FIG. 10;

FIG. 12 is a diagram illustrating an NG screen displayed in step S33 of FIG. 10;

FIG. 13 is a flowchart illustrating a former part of a process control program;

FIG. 14 is a flowchart illustrating a latter part of the process control program;

FIG. 15 is a flowchart illustrating a power interruption program; and

FIG. 16 is a diagram illustrating another example of the printing system.

### DETAILED DESCRIPTION

Hereinafter, exemplary embodiments of the invention will be described.

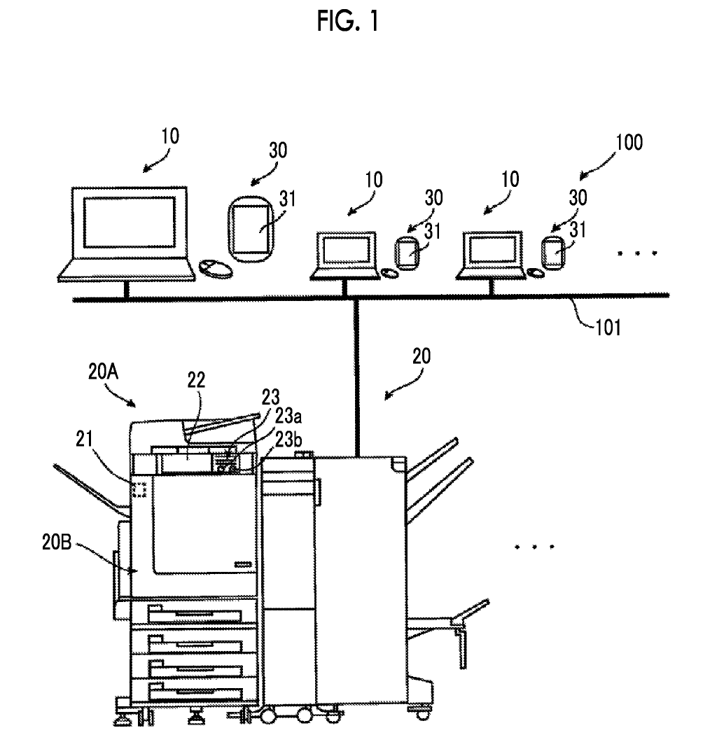

FIG. 1 is a diagram of a whole configuration of a printing system.

A printing system 100 includes plural note-type personal computers (hereinafter, abbreviated to “notebook PC”) 10 and plural multi-function machines 20. Furthermore, each of the notebook PCs 10 and each of the multi-function machines 20 are capable of communicating with each other through a communication circuit 101 such as a wireless Local Area Network (LAN).

In each notebook PC 10, a print job which instructs to print out is generated, and the print job is transmitted to the multi-function machine 20. It is possible to cause the print job to include various pieces of attached information, such as the number of copies, distinction between monochrome and color, and a size of paper used to print out, in addition to image data which is basis of printout on paper in the multi-function machine 20. In addition, the print job includes a user ID of a user who uses the notebook PC 10 of a transmission source.

In addition, each multi-function machine 20 includes a scanner 20A, a printer 20B, and the like, and has plural multiple functions such as a function as the scanner, a function as the printer, and a function as a copying machine which combines the scanner and the printer.

In addition, the multi-function machine 20 includes a short-range communicator 21. For example, the short-range communicator 21 is a wireless communicator conforming to the communication standards such as BLUETOOTH (registered trademark) which has a communication distance by approximately dozens of meters.

Furthermore, the multi-function machine 20 stores a user ID list in which a name and a user ID of the user who has use authority for the multi-function machine 20 are associated.

In addition, FIG. 1 illustrates mobile devices 30 such as smart phones. Each of the mobile devices 30 has a touch panel-type display screen 31, and has a function of performing communication with the short-range communicator 21 included in the multi-function machine 20. Each user who uses the printing system 100 is requested to always carry the mobile device 30 of each user. In each mobile device 30, the user ID of the user who carries the mobile device 30 is registered.

In a case where the multi-function machine 20 receives the print job from the notebook PC 10, the multi-function machine 20 determines whether or not the print job is a print job which is transmitted by a user who has use authority for the multi-function machine 20 with reference to a user ID included in the print job. In a case of the print job which is transmitted by the user who has the use authority for the multi-function machine 20, the multi-function machine 20 accumulates the print job in the multi-function machine 20. Furthermore, in a case where the user who possesses the mobile device 30 approaches the multi-function machine 20, user authentication is performed through short-range radio communication between the mobile device 30 possessed by the user and the short-range communicator 21 of the multi-function machine 20. In a case where it is determined to be a user who has use authority for the multi-function machine 20, printout is performed based on the accumulated print job of the user according to a user instruction. In addition, in a case where the user who arrives at a place of the multi-function machine 20 is the user who has use authority for the multi-function machine 20, image data, which is acquired through reading of a document by the scanner 20A according to the user instruction, is transmitted to the notebook PC 10 of the relevant user, and printout is performed based on the image data acquired through the reading.

In addition, the multi-function machine 20 includes a touch panel 22 and a push button group 23 which includes a start button 23a, an end button 23b, and the like.

Here, each multi-function machine 20 which forms the printing system 100 corresponds to an example of a processing apparatus according to the exemplary embodiment of the invention, and each mobile device 30 corresponds to an example of a mobile device according to the exemplary embodiment of the invention.

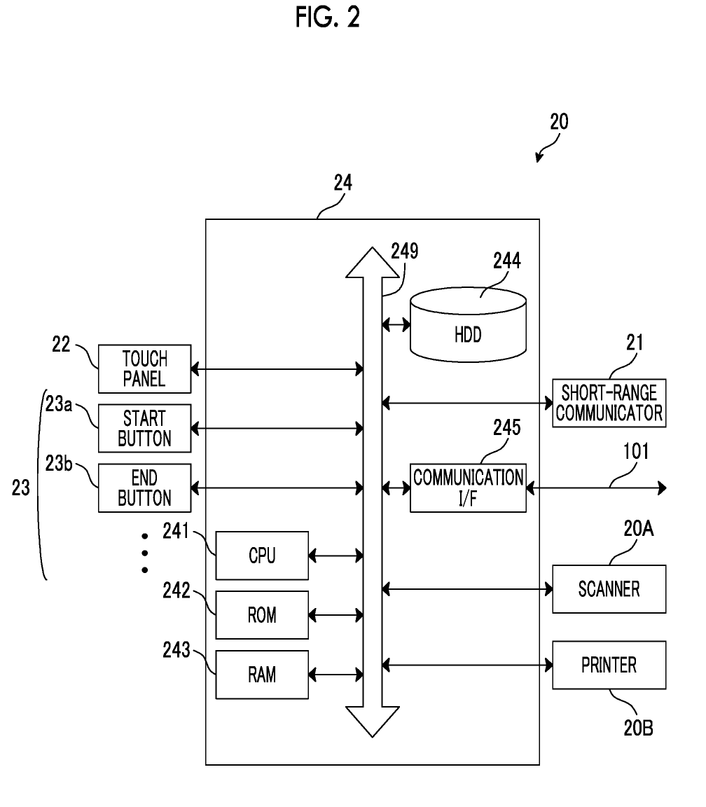

FIG. 2 is a diagram illustrating a hardware configuration of the multi-function machine illustrated in FIG. 1.

Here, the scanner 20A, the printer 20B, the short-range communicator 21, and the touch panel 22, which are illustrated in FIG. 1, and the push button group 23, which includes various push buttons such as the start button 23a and the end button 23b, are illustrated. Furthermore, here, a main controller 24 is illustrated. The main controller 24 has a function as an information processing apparatus which executes a program. Specifically, the main controller 24 includes a CPU 241, a ROM 242, a RAM 243, an HDD 244, and a communication I/F 245. Furthermore, the CPU 241, the ROM 242, the RAM 243, the HDD 244, and the communication I/F 245 are connected to be capable of communicating with each other through a bus 249.

The CPU 241 is a central processing unit and executes a program.

The ROM 242 is a read only memory. The ROM 242 stores a part of the program, which is executed by the CPU 241, and integers which are referred to by the program.

In addition, the RAM 243 is a memory in which a program to be executed is read from the HDD 244 and is stored in a case where the program is executed by the CPU 241. The RAM 243 is used as a work area which stores variables that are necessary in a case where the program is executed.

In addition, the HDD 244 is a hard disk drive in which a Hard Disk (HD) is built in. The HDD 244 stores various programs which are supposed to be executed by the CPU 241 and various data which are necessary to execute the programs. In addition, the HDD 244 stores the print job or the like which is transmitted from the notebook PC 10 or the like. The user ID or the like which is used to determine whether or not the use authority for the multi-function machine 20 exists is stored in the HDD 244.

Furthermore, the communication I/F 245 is a communication interface which performs communication with the notebook PC 10 through the communication circuit 101 illustrated in FIG. 1.

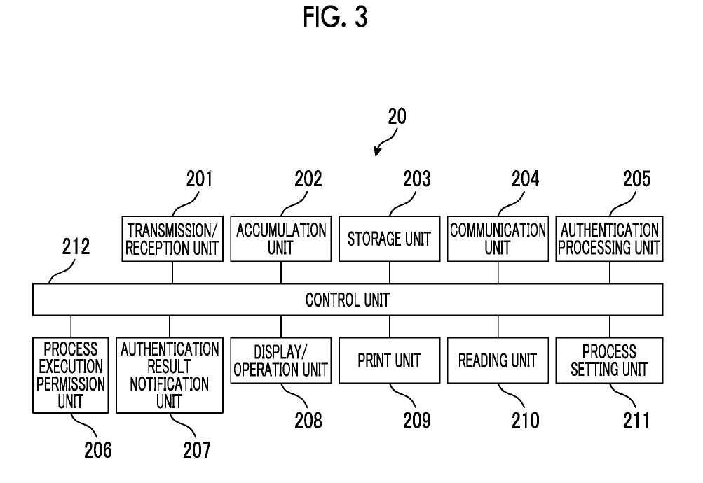

FIG. 3 is a functional block diagram of the multi-function machine illustrated in FIG. 1. Here, functions of the multi-function machine 20 will be generally described.

The multi-function machine 20 is a device which is requested to confirm a processing request from the user who has authority for a process, such as print or copy, before execution and which executes a process according to the user instruction.

FIG. 3 illustrates a transmission/reception unit 201, an accumulation unit 202, a memory 203, a communication unit 204, an authentication processing unit 205, a process execution permission unit 206, an authentication result notification unit 207, a display/operation unit 208, a printing unit 209, a reading unit 210, a process setting unit 211, and a control unit 212 as functional components of the multi-function machine 20.

The transmission/reception unit 201 receives a print job which is an instruction to print out and is transmitted from the notebook PC 10 (see FIG. 1) through the communication circuit 101. The print job includes the user ID which specifies the user who transmits the print job. The print job received by the transmission/reception unit 201 is transmitted to the accumulation unit 202 through the control unit 212, and is stored in the accumulation unit 202. In addition, the transmission/reception unit 201 transmits data, which is read and acquired by the reading unit 210 (scanner 20A), to the notebook PC 10. The communication I/F 245 illustrated in FIG. 2 takes a role as the transmission/reception unit 201 on the hardware.

In addition, the accumulation unit 202 accumulates the print job received by the transmission/reception unit 201 until printout is executed by the printing unit 209 based on the print job. The HDD 244 illustrated in FIG. 2 takes a role as the accumulation unit 202 on the hardware.

In addition, the memory 203 stores the user ID list in which a name of each user is associated with a user ID of each user who has use authority to use the multi-function machine 20. In addition, the memory 203 stores a multi-function machine ID for the multi-function machine 20 in order to specify the multi-function machine 20 by distinguishing between the multi-function machines 20 from each other. The HDD 244 illustrated in FIG. 2 takes a role as the memory 203 on the hardware. The memory 203 corresponds to an example of a first memory according to the exemplary embodiment of the invention.

In addition, the communication unit 204 performs wireless communication with the mobile device 30 which is possessed by the user, which is in a short distance from the multi-function machine 20, and which is moved to a predetermined communication area. The short-range communicator 21 illustrated in FIGS. 1 and 2 takes a role as the communication unit 204 on the hardware. The communication unit 204 corresponds to an example of a first communication unit according to the exemplary embodiment of the invention. In addition, in a case where the communication unit 204 receives both information that the mobile device 30 is in a “process request mode” and a user ID maintained by the mobile device through communication with the mobile device 30, the authentication processing unit 205 executes a user authentication process of determining whether or not the user ID received by the communication unit 204 is identical to any one of user IDs in the user ID list which is stored in the memory 203. Here, the “process request mode” is one processing mode in the mobile device 30 which is set or released through the user operation, and is mode in which a process of the multi-function machine 20 is requested to be executed. In the exemplary embodiment, a fact that a process setting program, which will be described later, is activated by the mobile device 30 indicates that the mobile device 30 is in the “process request mode”.

In addition, in addition that the mobile device 30 is in the “process request mode” and receives the user ID of the mobile device 30, the communication unit 204 further receives the multi-function machine ID which is set on a side of the mobile device 30. Furthermore, in a case where the multi-function machine ID, which is received by the communication unit 204 through communication with the mobile device 30, is the multi-function machine ID of the multi-function machine 20 in which the authentication processing unit 205 is included and in a case where both the information that the mobile device 30 is in the “process request mode” and the user ID are received by the communication unit 204, the authentication processing unit 205 executes the user authentication process. The main controller 24, which includes the CPU 241 or the like that executes the user authentication process program, takes a role as the authentication processing unit 205 on the hardware.

In addition, in a case where the authentication processing unit 205 confirms that the user ID received by the communication unit 204 is identical to any one of the user IDs in the user ID list stored in the memory 203, the process execution permission unit 206 permits to execute the process such as print or copy. Similar to the authentication processing unit 205, the main controller 24 takes a role as the process execution permission unit 206 on the hardware.

Furthermore, a process result notification unit 207 causes the communication unit 204 to notify a result of the user authentication process in the authentication processing unit 205, that is, success or failure in the user authentication to the mobile device 30, which is a current communication partner, through wireless communication. Similar to the authentication processing unit 205 and the process execution permission unit 206, the main controller 24 takes a role as the process result notification unit 207 on the hardware.

In addition, the display/operation unit 208 takes a role of notifying various pieces of information to the user through screen display and receiving various instructions from the user through the user operation. Here, the user operation in the display/operation unit 208 includes press of the start button 23a which instructs to execute print and copy and press of the end button 23b which notifies a fact that the use of the multi-function machine 20 is finished to the multi-function machine 20. The touch panel 22 and the push button group 23 take a role as the display/operation unit 208 on the hardware.

In addition, the printing unit 209 performs printout on paper. That is, the printing unit 209 performs printout based on the print jobs accumulated in the accumulation unit 202 based on the user instruction. The printer 20B illustrated in FIGS. 1 and 2 takes a role as the printing unit 209 on the hardware. The printing unit 209 becomes a part of a process execution unit according to the exemplary embodiment of the invention.

In addition, the reading unit 210 takes a role of reading an image on the document and acquiring the image data. The image data acquired by the reading unit 210 is transmitted to the notebook PC 10 through the transmission/reception unit 201 or transmitted to the printing unit 209 and an image is printed out based on the image data. The scanner 20A illustrated in FIGS. 1 and 2 takes a role as the reading unit 210 on the hardware. The reading unit 210 forms an example of a process execution unit according to the exemplary embodiment of the invention, together with the printing unit 209.

Here, the communication unit 204 receives the user instruction which is set on the side of the mobile device 30 and prescribes processing content in the process execution unit (the scanner 20A and the printer 20B). Thereafter, the process setting unit 211 sets the process execution unit (the scanner 20A and the printer 20B) in a state in which a process according to the user instruction received by the communication unit 204 is executed. Furthermore, in a case where the start button 23a (see FIGS. 1 and 2) is pressed, the process execution unit, which includes the reading unit 210 and the printing unit 209 (the scanner 20A and the printer 20B), executes the process which is set by the process setting unit 211. The main controller 24 takes a role as the process setting unit 211 on the hardware.

Furthermore, the control unit 212 is in charge of controlling the whole of the multi-function machine 20 and delivering data and commands.

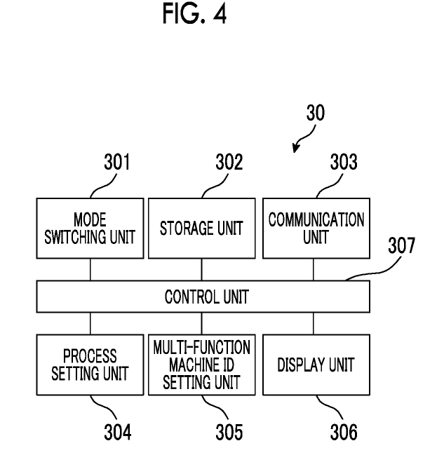

FIG. 4 is a functional block diagram of the mobile device illustrated in FIG. 1.

The mobile device 30 is a device which is possessed by the user, maintains a user ID indicating that the user is a user who has use authority to use the multi-function machine 20, and performs wireless communication with the multi-function machine 20 in a case where a distance between the mobile device 30 and the multi-function machine 20 approaches within a predetermined short-range distance. In addition, in the mobile device 30, a function is embedded as the information processing apparatus which includes the CPU or the like that executes programs, and various programs are executed.

FIG. 4 illustrates a mode switching unit 301, a memory 302, a communication unit 303, a process setting unit 304, a multi-function machine ID setting unit 305, a display 306, and a control unit 307 as components of the mobile device 30.

The mode switching unit 301 switches into any one mode among plural modes including the “process request mode” which is set and released by the user operation and in which execution of a process in the multi-function machine 20 is requested. As described above, in a case of the exemplary embodiment, activation of the process setting program, which instructs the multi-function machine 20 about the processing content, means switching into the “process request mode”, and end of the process setting program means release of the “process request mode”.

The CPU or the like, which executes the programs in the touch panel-type display screen 31 and the mobile device 30 that receives the user operation, takes a role as the mode switching unit 301 on the hardware. The mode switching unit 301 corresponds to an example of a mode switching unit according to the exemplary embodiment of the invention.

In addition, the memory 302 stores the user ID of the user who possesses the mobile device 30 and the multi-function machine ID which specifies the multi-function machine 20 in which the user has use authority. The memory 302 corresponds to an example of a second memory of the mobile device according to the exemplary embodiment of the invention.

In addition, the communication unit 303 performs wireless communication with the multi-function machine 20 in a case where the mobile device 30 is moved to the communication area with respect to the multi-function machine 20. Furthermore, the communication unit 303 transmits information that the mobile device 30 is in the “process request mode”, that is, information that the process setting program is activated in the mobile device 30, and the user ID stored in the memory 302 to the multi-function machine 20. In addition, the communication unit 303 also transmits the multi-function machine ID which designates the multi-function machine 20 that is supposed to be used by the user. The communication unit 303 corresponds to an example of a second communication unit according to the exemplary embodiment of the invention. For example, a short-range communication function, such as BLUETOOTH (registered trademark), included in the mobile device 30 takes a role as the communication unit 303 on the hardware.

In addition, the process setting unit 304 sets the “user instruction” which prescribes the processing content to be executed by the multi-function machine 20 according to the user operation. The CPU or the like, which executes the process setting program in the touch panel-type display screen 31 and the mobile device 30, takes a role as the process setting unit 304 on the hardware. The process setting unit 304 corresponds to an example of a process setting unit according to the exemplary embodiment of the invention.

The “user instruction”, which is set by the process setting unit 304, is transmitted to the multi-function machine 20 through wireless communication with the multi-function machine 20 in a case where the user who possesses the mobile device 30 moves in the communication area with respect to the multi-function machine 20 at right time.

In addition, in a case where the plural multi-function machines 20 are installed, the multi-function machine ID setting unit 305 sets a multi-function machine ID which specifies a multi-function machine 20 supposed to execute the process according to the user operation. Furthermore, the multi-function machine ID, which is set by the multi-function machine ID setting unit 305, is transmitted to the multi-function machine 20 by the communication unit 303. Similar to the process setting unit 304, the CPU or the like, which executes the program in the touch panel-type display screen 31 and the mobile device 30, takes a role as the multi-function machine ID setting unit 305 on the hardware. The multi-function machine ID setting unit 305 corresponds to an example of a device ID setting unit according to the exemplary embodiment of the invention.

Furthermore, the display 306 receives success or failure in the user authentication which is transmitted from the multi-function machine 20 by the communication unit 303, and displays a result of the success or failure in the user authentication received by the communication unit 303 on the display screen 31. The CPU or the like, which executes a program of performing display on the display screen 31, takes a role as the display 306 on the hardware. The display 306 corresponds to an example of a notification unit according to the exemplary embodiment of the invention.

Furthermore, the control unit 307 is in charge of controlling the whole of the mobile device 30 and delivering data and commands.

Hereinafter, a process executed in the multi-function machine 20 and the mobile device 30 will be described in detail by describing various programs which are executed in the multi-function machine 20 or the mobile device 30. Here, in description below, a general term of a program which is executed in the multi-function machine 20 corresponds to an example of a process control program according to the exemplary embodiment of the invention, and a general term of a program which is executed in the mobile device 30 corresponds to an example of an authentication request program according to the exemplary embodiment of the invention.

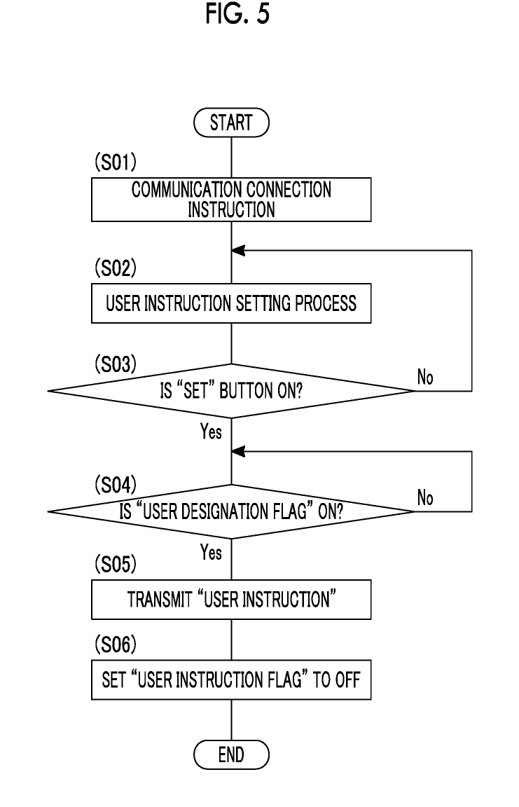

FIG. 5 is a flowchart illustrating the process setting program which is executed in the mobile device.

The process setting program illustrated in FIG. 5 is activated by an activation operation of the user who possesses the mobile device 30. As described above, activation of the process setting program means an operation of switching into the “process request mode”.

In a case where the process setting program illustrated in FIG. 5 is activated, here, first, a “communication connection instruction” is performed (step S01). The “communication connection instruction” is an instruction which is provided to the communication unit 303 of the mobile device 30 to perform communication connection with the multi-function machine 20. However, even in a case where the “communication connection instruction” is performed, the communication connection is not performed in a case where the mobile device 30 is at a distance separated from the multi-function machine 20, and the communication connection is performed in a case where the mobile device 30 moves in the above-described communication area.

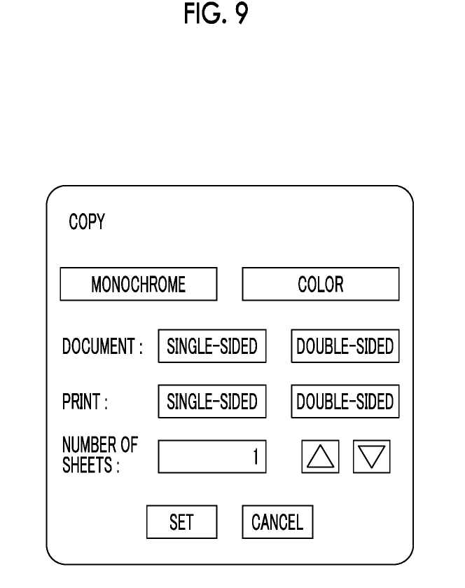

In the process setting program illustrated in FIG. 5, “user instruction setting” is performed (step S02) until a “set” button (see FIG. 9) is pressed (step S03) after the “communication connection instruction” is performed (step S01).

Here, the “user instruction setting” will be illustrated.

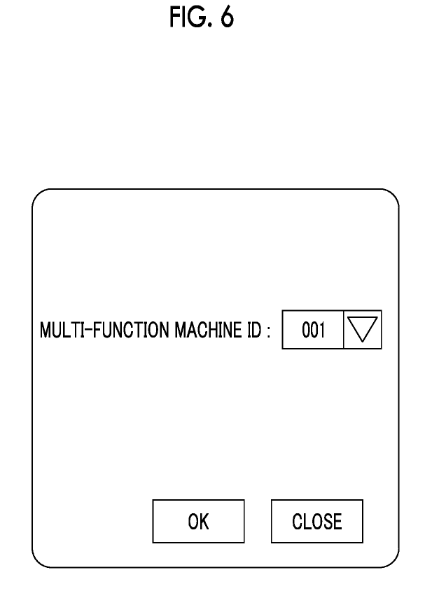

FIG. 6 illustrates a multi-function machine ID setting screen. A multi-function machine ID setting screen 311 is a screen which is initially displayed on the display screen 31 of the mobile device 30 in a “user instruction setting” step (step S02).

Here, the plural multi-function machines 20 whose use authority is given to the user who possesses the mobile device 30 are installed, and multi-function machine IDs of the plural multi-function machines 20 whose use authority is given to the user are stored in the memory 302 of the mobile device 30. Therefore, here, the multi-function machine ID setting screen 311 illustrated in FIG. 6 is displayed on the display screen 31 of the mobile device 30, and a multi-function machine ID of a multi-function machine 20, which is supposed to be currently executed by the user, is set on the multi-function machine ID setting screen 311.

Here, the memory 302 stores an ID 001 and an ID 002 as the multi-function machine IDs of the plural multi-function machines 20 to which use permission is given. Furthermore, the ID 001 is selected on the multi-function machine ID setting screen 311 illustrated in FIG. 6. In a case where an “OK” button on the multi-function machine ID setting screen 311 is pressed, the multi-function machine 20 supposed to execute the current process is decided.

In contrast, in a case where a “close” button is pressed, the activated process execution program (see FIG. 5) is forcedly ended.

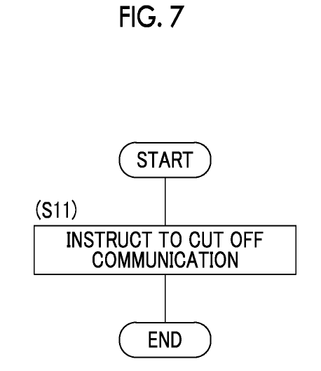

FIG. 7 is a flowchart of a communication cut-off program which is activated in a case where the execution of the process setting program is ended.

In a case where the “close” button is pressed on the multi-function machine ID setting screen 311 illustrated in FIG. 6, the process setting program illustrated in FIG. 5 is forcedly ended, the communication cut-off program illustrated in FIG. 7 is activated with the forced end of the process setting program as a trigger. Furthermore, here, a “communication cut-off instruction”, which cancels the “communication connection instruction” in step S01 of the process setting program of FIG. 5, is performed (step S11). In a case where the “communication cut-off instruction” is performed, a state before the short-range communication starts between the mobile device 30 and the multi-function machine 20 is maintained without change. Also, thereafter, a state is brought in which communication is not performed therebetween. In addition, in a case where the “communication cut-off instruction” is performed and the short-range communication between the mobile device 30 and the multi-function machine 20 is already started, a state is brought in which the communication is cut off and communication connection thereafter is not performed.

That is, this means that, in a case where the “close” button is pressed on the multi-function machine ID setting screen 311 illustrated in FIG. 6 and the process setting program illustrated in FIG. 5 is forcedly ended, the “process request mode” is released.

Meanwhile, the communication cut-off program illustrated in FIG. 7 is activated not only in the case where the “close” button is pressed on the multi-function machine ID setting screen 311 illustrated in FIG. 6 and the process setting program illustrated in FIG. 5 is forcedly ended but also in the case where the process setting program illustrated in FIG. 5 is normally ended.

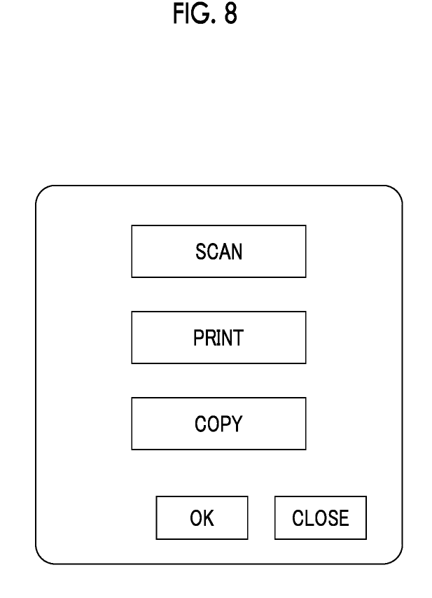

FIG. 8 is a diagram illustrating a function setting screen.

In a case where an “OK” button is pressed on the multi-function machine ID setting screen 311 illustrated in FIG. 6, a function setting screen 312 illustrated in FIG. 8 is displayed on the display screen 31 of the mobile device 30 instead of the multi-function machine ID setting screen 311.

A process function which is executed in the multi-function machine 20 roughly includes three types of “scan”, “print”, and “copy”. Here, “scan” is a process function of acquiring the image data by reading the document in the scanner 20A and transmitting the image data to the notebook PC 10. In addition, “print” is a process function of causing the printer 20B to print out based on the print job which is transmitted from the notebook PC 10 and is accumulated in the multi-function machine 20. Furthermore, “copy” is a process function of acquiring the image data by reading the document in the scanner 20A and causing the printer 20B to print out based on the image data.

Here, in a case where any one of “scan”, “print”, and “copy” buttons is pressed on the function setting screen 312 illustrated in FIG. 8, the process function, which is supposed to be currently performed by the multi-function machine 20, is selected among the three types of process functions, and, further, and the “OK” button is pressed. If so, the selected process function is decided as the process function which should be currently executed in the multi-function machine 20.

In contrast, in a case where the “close” button is pressed without pressing the “OK” button on the function setting screen 312, the function setting screen 312 disappears, and the multi-function machine ID setting screen 311 illustrated in FIG. 6 is displayed instead of the function setting screen 312.

Here, in a case where only one multi-function machine ID is stored in the memory 302 of the mobile device 30, that is, in a case where there is only one multi-function machine 20 which can be used by the user who possesses the mobile device 30, the multi-function machine ID setting screen 311 illustrated in FIG. 6 is not displayed. In a case where the multi-function machine ID setting screen 311 is not displayed, the process setting program illustrated in FIG. 5 is forcedly ended in a case where the “close” button on the function setting screen 312 illustrated in FIG. 8 is pressed.

Here, as an example, it is assumed that the “copy” button is pressed and the “OK” button is further pressed on the function setting screen 312 illustrated in FIG. 8. If so, a “copy” menu screen, which will be described later, is displayed on the display screen 31 of the mobile device 30 instead of the function setting screen 312. Meanwhile, in a case where the “scan” button or the “print” button is pressed and the “OK” button is pressed on the function setting screen 312 illustrated in FIG. 8, a “scan” menu screen or a “print” menu screen is displayed, respectively. However, here, the menus screens will not be described, and, here, the “copy” menu screen will be described as an example.

FIG. 9 is a diagram illustrating the “copy” menu screen.

Setting of “monochrome” copy or “color” copy, setting of a “single-sided” document or a “double-sided” document, setting of “single-sided” print or “double-sided” print, and setting of the number of copies are performed on a copy” menu screen 313 illustrated in FIG. 9. In a case where the settings are performed and the “set” button is pressed, the “user instruction” of instructing to execute a process according to the settings is settled. In contrast, in a case where a “cancel” button is pressed without pressing the “set” button, the process returns to the display of the function setting screen 312 illustrated in FIG. 8.

Description will be continued after returning to FIG. 5.

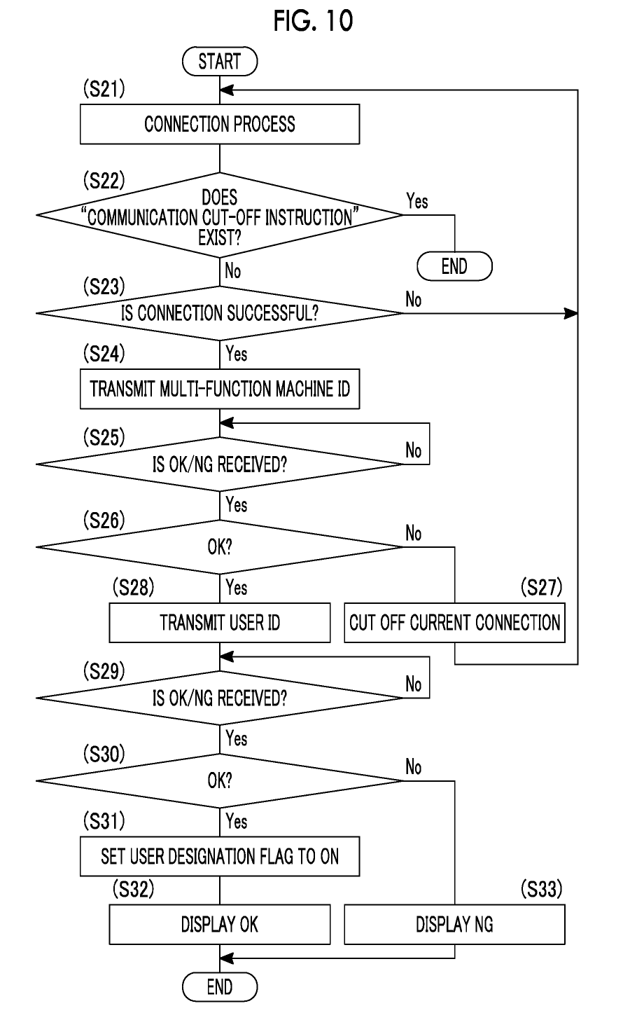

In step S02 of FIG. 5, the user instruction setting process, which is described with reference to FIGS. 6, 8, and 9, is executed until the “set” button on the menu screen (for example, the “set” button on the “copy” menu screen illustrated in FIG. 9. The “set” buttons are provided on the “scan” and “print” menu screens which are not shown in the drawing) is pressed (step S03). Furthermore, in a case where the “set” button is pressed, subsequently, it is determined whether or not a “user instruction flag” is ON or OFF (step S04). The “user instruction flag” is a flag which indicates whether or not timing, at which the “user instruction” that is set as described above is transmitted to the multi-function machine 20, arrives, and is set to ON in step S31 of FIG. 10 which will be described later.

In the process setting program illustrated in FIG. 5, a waiting state is continued until it is determined that the “user instruction flag” is ON in step S04. In a case where it is determined that the “user instruction flag” is ON, the “user instruction” which is set in step S02 is transmitted to the multi-function machine 20 (step S05), and the “user instruction flag” becomes clear (OFF) (step S06).

FIG. 10 is a flowchart illustrating a communication program.

The communication program illustrated in FIG. 10 is a program which is activated by receiving the “communication connection instruction” in step S01 of the process setting program illustrated in FIG. 5 and is executed within the mobile device 30.

Here, first, a communication connection process executed with the multi-function machine 20 (step S21) is repeated until connection is successful (step S03). In a case where the “communication cut-off instruction” is provided while communication connection is attempted (step S02), the communication connection process is not executed after a point of time at which the “communication cut-off instruction” is provided. The “communication cut-off instruction” is issued in a case where the execution of the process execution program illustrated in FIG. 5 is forcedly ended by pressing the “close” button on the multi-function machine ID setting screen 311 illustrated in FIG. 6 and in a case where the execution of the process execution program is normally ended.

In a case where the “communication cut-off instruction” is not provided (step S22) and communication connection with the multi-function machine 20 is successful (step S23), the mobile device 30 transmits the multi-function machine ID (see FIG. 6), which specifies the multi-function machine 20 supposed to be currently used, to the multi-function machine 20 (step S24).

If so, the multi-function machine 20, which has received the multi-function machine ID, transmits a response of OK/NG which indicates whether the received multi-function machine ID is a multi-function machine ID of the multi-function machine (OK) or is not the multi-function machine ID of the multi-function machine 20 (NG), and the mobile device 30 receives the response (step S25). Furthermore, in a case where the response from the multi-function machine 20 is NG (step S26), communication with the currently connected multi-function machine 20 is cut off (step S27), the process returns to the step S21, and the communication connection process is executed with another multi-function machine 20.

In contrast, in a case where the response from the multi-function machine 20 which is relevant to the multi-function machine ID is OK (the multi-function machine ID of the multi-function machine 20) (step S26), subsequently, the user ID of the user who possesses the mobile device 30, that is, the user ID which is stored in the mobile device 30 is transmitted to the relevant multi-function machine 20 (step S28).

The user ID list of users who have authority to use the multi-function machine 20 is associated with names of the respective users and is stored in the multi-function machine 20. Furthermore, in a case where the multi-function machine receives a user ID from the mobile device 30, the multi-function machine 20 detects (user authentication process) whether or not a user ID which is the same as the received user ID is included in the user ID list which is stored in the multi-function machine 20, and sends a reply indicative of OK (success in authentication) which means that the user ID is included in the user list or NG (failure in authentication) which means that the user ID is not included in the user list to the mobile device 30.

In a case where the mobile device 30 receives the reply (step S29), the mobile device 30 determines whether the received response is OK (success in authentication) or NG (failure in authentication) (step S30). Furthermore, in a case where the response relevant to the user ID is OK (success in authentication) (step S30), a “user designation flag” is set to ON (step S31), and OK display is performed on the display screen 31 of the mobile device 30 (step S32). The OK display will be described after description with reference to FIG. 10 ends.

Here, a case where the “user designation flag” is set to ON means that timing, at which a side of the multi-function machine 20 receives “user designation” set in step S02 of FIG. 5, arrives.

In contrast, in a case where the response relevant to the user ID is NG (failure in authentication) (step S30), NG display is performed on the display screen 31 of the mobile device 30 (step S33).

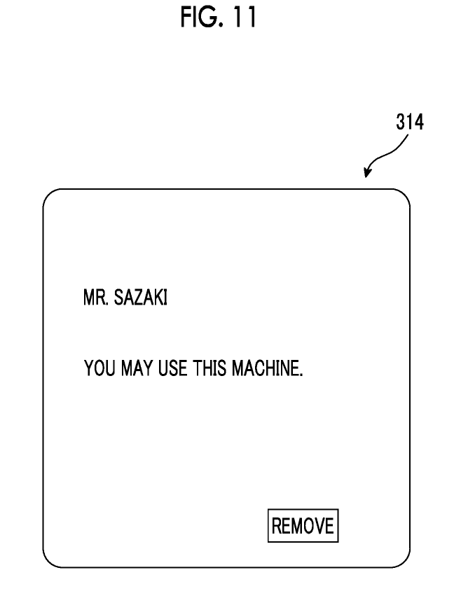

FIG. 11 is a diagram illustrating an OK screen which is displayed in step S32 of FIG. 10.

On the OK screen 314 illustrated here, a name of a current user (here, Mr. SAZAKI) and a message “You may use this machine.”, which permits the use of the multi-function machine 20, are displayed.

In a case where a “remove” button on the OK screen 314 is pressed, the OK screen 314 disappears from the display screen 31 of the mobile device 30.

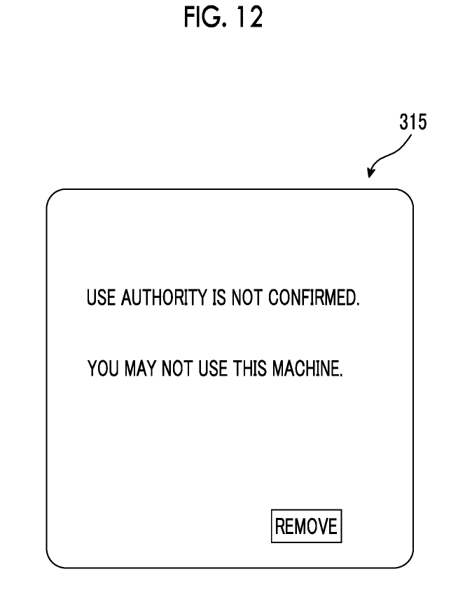

FIG. 12 is a diagram illustrating an NG screen which is displayed in step S33 of FIG. 10.

A message “Use authority is not confirmed. Please refrain from using” which denies the use of the multi-function machine 20 is displayed on an NG screen 315 illustrated here. In a case where a “remove” button on the NG screen 315 is pressed, the NG screen 315 disappears from the display screen 31 of the mobile device 30.

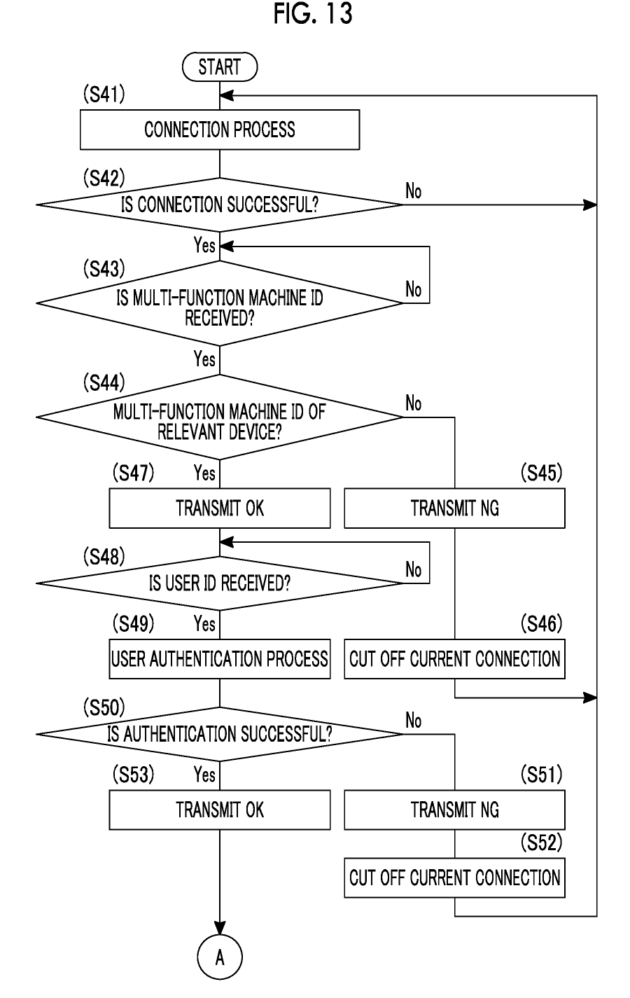

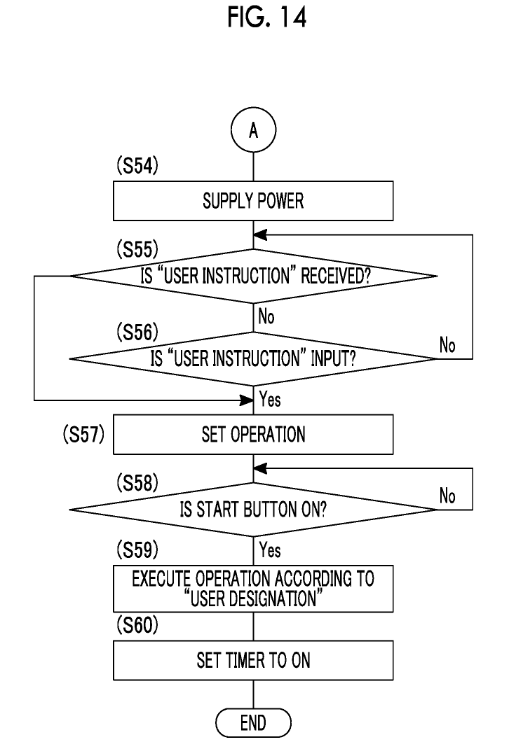

FIGS. 13 and 14 are flowcharts illustrating a former part and a latter part of the process control program, respectively. The process control program is a program which is executed in the multi-function machine 20.

Here, in the multi-function machine 20, power is always supplied to at least spots which are necessary to maintain the short-range communication function with the mobile device 30 and to execute the process control program. In contrast, in the multi-function machine 20, power supplied to other spots accompanied with high power consumption, for example, the scanner 20A and the printer 20B is usually cut off, and power is supplied at necessary timing.

In the multi-function machine 20, the communication connection process (step S41) is repeated until the communication connection with the approaching mobile device 30 is successful (step S42).

Furthermore, in a case where the communication connection is successful (step S42), the multi-function machine 20 waits to receive the multi-function machine ID transmitted from the mobile device 30 which is a current communication partner (step S43). In a case where the multi-function machine ID is received, the multi-function machine 20 checks whether the received multi-function machine ID is a multi-function machine ID of the multi-function machine (step S44). Furthermore, in a case where the received multi-function machine ID is not the multi-function machine ID of the multi-function machine 20, the multi-function machine 20 transmits a response, which notifies that the multi-function machine ID is NG, to the mobile device 30 (step S45), and cuts off the communication with the currently connected mobile device 30 (step S46). The process returns to step S41 and the communication connection process is executed with another mobile device 30.

In contrast, in a case where the multi-function machine ID is the multi-function machine ID of the multi-function machine 20 (step S44), the multi-function machine 20 transmits a response which notifies that the multi-function machine ID is OK (step S47).

In a case where the mobile device 30 receives the OK response for the multi-function machine ID, the mobile device transmits the user ID (step S28 of FIG. 10). The multi-function machine 20 waits to receive the user ID from the mobile device 30 (step S48), and executes the user authentication process (step S49). The user authentication process according to the exemplary embodiment is a process of detecting whether or not the same user ID as the received user ID is identical to any one of user IDs, which are registered as the users who have authority to use the multi-function machine 20, in the user ID list, determining to be the success in authentication in a case where an identical user ID exists, and determining to be the failure in authentication in a case where the identical user ID is not found.

In a case of the failure in authentication (step S50) as a result of the user authentication process, an NG response relevant to the user ID is transmitted (step S51), furthermore, communication with the currently connected mobile device 30 is cut off (step S52), the process returns to step S41, and the communication connection process is executed with another mobile device 30.

In contrast, in a case of the success in authentication (step S50) as the result of the user authentication process, an OK response relevant to the user ID is transmitted to the mobile device 30 which is the current communication partner (step S53), and power is supplied to the multi-function machine 20 (step S54 of FIG. 14). Meanwhile, as described above, power is always supplied to some spots of the multi-function machine 20, and thus, here, the supply of power indicates the supply of power to remaining spots.

Subsequently, it is determined whether the “user instruction”, which is transmitted by the mobile device 30, is received (step S55) or the “user instruction” through an operation performed on the multi-function machine 20 exists (step S56).

In a case of the exemplary embodiment, as described above with reference to FIGS. 6, 8, and 9, the “user instruction” is set on the side of the mobile device 30 (see step S02 of FIG. 5). Furthermore, the set “user instruction” is transmitted to the multi-function machine 20 (step S05 of FIG. 5) after the OK response relevant to the user ID is received (steps S29 and S30 in FIG. 10) and the “user designation flag” becomes ON (step S31 of FIG. 10 and step S04 of FIG. 5).

Here, the “communication connection instruction” is performed in step (step S01 of FIG. 5) before “user instruction” setting step (step S02 of FIG. 5) performed in the mobile device 30. Therefore, even in a case where the “user instruction” is not set in the mobile device 30, communication is performed between the mobile device 30 and the multi-function machine 20. Here, it is possible for the user to set the “user instruction” by operating the touch panel 22 and the operation button group 23 of the multi-function machine 20 instead of the mobile device 30 after the OK response relevant to the user ID acquired through the user authentication process is arrived at the mobile device 30. However, in a case where the “user designation” is set on the side of the mobile device 30, time is reduced which is taken until the process, such as copy, starts from when the user arrives in front of the multi-function machine 20, compared to a case where the “user instruction” is set through the operation performed on the multi-function machine 20. Meanwhile, in a case where the plural multi-function machine IDs are stored in the mobile device 30, it is necessary to perform the setting of the multi-function machine ID of the multi-function machine 20, which is supposed to be used from now on, on the side of the mobile device 30, the setting being described with reference to FIG. 6.

In a case where the “user instruction” which is set on the side of the mobile device 30 is received (step S55 of FIG. 14) or the “user instruction” is input through the operation performed on the touch panel 22 or the like of the multi-function machine 20, the “operation setting”, that is, adjustment is performed on states of respective components such that the scanner 20A and the printer 20B operate according to the “user instruction” (step S57).

Furthermore, in a case where the start button 23a (see FIGS. 1 and 2) included in the multi-function machine 20 is pressed (step S58), for example, an operation, such as a copy operation, is executed according to the current “user designation” in the multi-function machine 20 (step S59). Meanwhile, instead of pressing the start button 23a of the multi-function machine 20, an operation start instruction may be transmitted from the mobile device 30 according to the operation performed on the mobile device 30.

Here, an operation according to the current “user designation” is executed (step S59) using the pressing of the start button 23a or the operation start instruction from the mobile device 30 as an opportunity, and, further, a timer is activated (step S60).

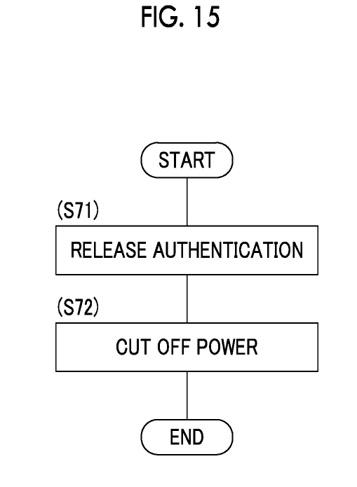

FIG. 15 is a flowchart illustrating a power interruption program.

The power interruption program is a program which is executed in the multi-function machine 20 in a case where time of the timer activated in step S60 of FIG. 14 is up or the end button 23b (see FIGS. 1 and 2) included in the multi-function machine 20 is pressed.

Here, first, the authentication is released (step S71). The reason for this is to avoid illegal use of the multi-function machine 20 by another user in a case where power is subsequently supplied to the multi-function machine 20 and information of success in authentication of a previous user remains.

Here, subsequently, power which is supplied to the multi-function machine 20 is cut off (step S72). However, as described above, power supply to maintain the communication function or the like with the mobile device 30 is continued.

Here, the user who has used the multi-function machine 20 presses the end button 23b in a case where the user leaves the place of the multi-function machine 20. If so, the power interruption program illustrated in FIG. 15 is executed and power of the multi-function machine 20 is cut off. However, it is conceivable that the user forgets to press the end button 23b and leaves the place of the multi-function machine 20. In this case, the power of the multi-function machine 20 is cut off after waiting for the timer activated in step S60 of FIG. 14 to time up.

Meanwhile, although not described in the flowchart, for example, it is conceivable that the user leaves while the touch panel 23a is being operated. Therefore, even in a case where predetermined time elapses without performing any operation on the multi-function machine 20, the power interruption program of FIG. 15 is executed and the power of the multi-function machine 20 is cut off.

Subsequently, another form of the user authentication process will be described.

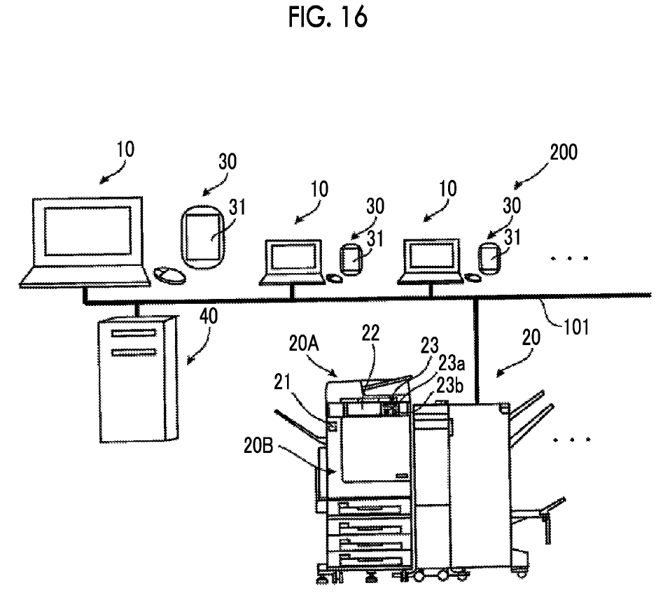

FIG. 16 is a diagram illustrating another example of the printing system.

In a printing system 200 illustrated in FIG. 16 further includes a server 40 in addition to the respective components which form the printing system 100 illustrated in FIG. 1. The server 40 stores a user ID list, in which a user name and a user ID of a user who has authority to use each multi-function machine 20 are associated, for each multi-function machine 20 which forms the printing system 200 illustrated in FIG. 16.

In contrast, each multi-function machine 20 does not store the user ID list which indicates use authority for each multi-function machine 20.

Furthermore, in the printing system 200 illustrated in FIG. 16, in a case where the communication unit 204 receives the user ID from the mobile device 30, the authentication processing unit 205 (see FIG. 3) of each multi-function machine 20 causes the transmission/reception unit 201 to transmit the multi-function machine ID of the multi-function machine 20 and the received user ID to the server 40, thereby inquiring whether the user ID is a user ID of the user who has authority to use the multi-function machine 20. In a case where the server 40 receives the inquiry, the server 40 searches the user ID list, which is stored in the server 40 and is relevant to the querying multi-function machine 20, detects whether or not the same user ID as the inquired user ID exists in the user ID list, and respond a detection result to the querying multi-function machine 20. The multi-function machine 20, which performed the inquiry, recognizes the user who has the user ID is the user who has authority to use the multi-function machine 20 according to the response.

According to the user authentication process of the exemplary embodiment, it is possible to collectively manage the user who has the use authority for each multi-function machine 20 by the server 40 while being separated from each multi-function machine 20 without managing the user who has the use authority for each multi-function machine 20 by the multi-function machine 20, and thus it is easy to switch between the multi-function machine 20.

The server 40 corresponds to an example of an external device according to the exemplary embodiment of the invention.

Here, each exemplary embodiment is configured such that the user authentication process is executed only in a case where the user ID transmitted from the mobile device 30 is received. Therefore, in a case of the above-described exemplary embodiment, it is necessary for the user who attempts to use the multi-function machine 20 to carries the mobile device 30. A user authentication process (for example, user authentication process using password input, fingerprint authentication, an IC card, and the like) may be executed together by considering a user who does not possess the mobile device 30 or a user who considers that it does not matter even though hours are extended, for example, until the copy operation or the like starts after the user arrives at the place of the multi-function machine 20.

In addition, in each exemplary embodiment, the process setting program is activated in the mobile device 30 and the mobile device 30 is in the “process request mode”. However, the “process request mode” may express an intention of using the multi-function machine 20 by the user from now on, and states other than the state, in which the process setting program is activated, may be the “process request mode”. For example, the user who possesses the mobile device 30 operates the mobile device, and performs an operation of making a flag, which expresses the intention of using the multi-function machine 20 from now on, ON. Therefore, it may be considered that the mobile device 30 is in the “process request mode” based on a fact that the flag is ON. In this case, an ON/OFF state of the flag is transmitted to the multi-function machine 20 in communication between the mobile device 30 and the multi-function machine 20.

In addition, each exemplary embodiment is configured such that it is possible to perform the “user designation” on the side of the mobile device 30. The “user designation”, in which the process up to the user authentication process is not executed in communication with the mobile device 30, may be formed by an operation performed on the touch panel 23a or the like after the user arrives at the place of the multi-function machine 20.

In addition, in each exemplary embodiment is configured such that it is necessary to execute the user authentication even in a case where any one of the process functions (scan, print, and copy), which are performed by the multi-function machine 20, is used. However, it is possible for anyone to use a part of the process functions without performing the user authentication. Even in a configuration in which it is necessary to perform the user authentication for remaining process functions, it is possible to apply the exemplary embodiment of the invention to the process function which requires the user authentication.

Furthermore, here, the multi-function machine 20 illustrated in FIG. 1 is particularly described. However, the exemplary embodiment of the invention is not applied to only the multi-function machine 20 and it is possible to widely apply the exemplary embodiment of the invention to a processing apparatus which executes some processes, in which it is necessary to perform the user authentication, before the process is executed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A processing apparatus comprising:
a process execution unit that executes a process according to a user instruction;
a first communication unit that performs wireless communication with a mobile device which is moved to a predetermined communication area;
an authentication processing unit that, in a case where the first communication unit receives both information that the mobile device is in a process request mode, which requests to execute the process in the process execution unit and which is set and released by a user operation performed on the mobile device, and a user ID which is maintained by the mobile device through communication with the mobile device, executes a user authentication process of recognizing whether or not a user who has the reception user ID received by the first communication unit is a user who has authority to cause the process execution unit to execute at least part of necessary authentication process among processes which can be executed by the process execution unit; and
a process execution permission unit that, in a case where the reception user ID is recognized as a user ID possessed by the user who has the authority to cause the authentication processing unit to execute the necessary authentication process, permits the process execution unit to execute the necessary authentication process.

2. The processing apparatus according to claim 1, further comprising:
a first memory that stores the user ID of the user who has the authority to cause the process execution unit to execute the necessary authentication process,
wherein the authentication processing unit determines whether or not the reception user ID received by the first communication unit is identical to any one storage user ID among user IDs stored in the first memory, and permits the process execution unit to execute the necessary authentication process in a case where the reception user ID is identical to the storage user ID, as the user authentication process.

3. The processing apparatus according to claim 1, wherein the authentication processing unit inquires of an external device, in which the user ID of the user who has the authority to cause the process execution unit to execute the necessary authentication process is registered, about whether or not a same user ID as the reception user ID received by the first communication unit is registered as the user ID of the user who has the authority to cause the process execution unit to execute the necessary authentication process, and permits the process execution unit to execute the necessary authentication process in a case where the reception user ID is recognized as the user ID of the user who has the authority to cause the process execution unit to execute the necessary authentication process based on a response with respect to the inquiry, as the user authentication process.

4. The processing apparatus according to claim 1, wherein the processing apparatus has a device ID,
wherein the first communication unit receives the device ID through communication with the mobile device, and
wherein the authentication processing unit executes the user authentication process in a case where the device ID received by the first communication unit through communication with the mobile device is the device ID of the processing apparatus and in a case where the first communication unit receives both the information that the mobile device is in the process request mode and the reception user ID.

5. The processing apparatus according to claim 2, wherein the processing apparatus has a device ID,
wherein the first communication unit receives the device ID through communication with the mobile device, and
wherein the authentication processing unit executes the user authentication process in a case where the device ID received by the first communication unit through communication with the mobile device is the device ID of the processing apparatus and in a case where the first communication unit receives both the information that the mobile device is in the process request mode and the reception user ID.

6. The processing apparatus according to claim 3, wherein the processing apparatus has a device ID,
wherein the first communication unit receives the device ID through communication with the mobile device, and
wherein the authentication processing unit executes the user authentication process in a case where the device ID received by the first communication unit through communication with the mobile device is the device ID of the processing apparatus and in a case where the first communication unit receives both the information that the mobile device is in the process request mode and the reception user ID.

7. The processing apparatus according to claim 1, further comprising:
an authentication result notification unit that causes the first communication unit to notify a result of the user authentication process in the authentication processing unit to the mobile device, which is a current communication partner, through the wireless communication.

8. The processing apparatus according to claim 2, further comprising:
an authentication result notification unit that causes the first communication unit to notify a result of the user authentication process in the authentication processing unit to the mobile device, which is a current communication partner, through the wireless communication.

9. The processing apparatus according to claim 3, further comprising:
an authentication result notification unit that causes the first communication unit to notify a result of the user authentication process in the authentication processing unit to the mobile device, which is a current communication partner, through the wireless communication.

10. The processing apparatus according to claim 4, further comprising:
an authentication result notification unit that causes the first communication unit to notify a result of the user authentication process in the authentication processing unit to the mobile device, which is a current communication partner, through the wireless communication.

11. The processing apparatus according to claim 5, further comprising:
an authentication result notification unit that causes the first communication unit to notify a result of the user authentication process in the authentication processing unit to the mobile device, which is a current communication partner, through the wireless communication.

12. The processing apparatus according to claim 6, further comprising:
an authentication result notification unit that causes the first communication unit to notify a result of the user authentication process in the authentication processing unit to the mobile device, which is a current communication partner, through the wireless communication.

13. The processing apparatus according to claim 1,
wherein the first communication unit receives a user instruction which is set on a side of the mobile device and prescribes processing content in the process execution unit, and
wherein the processing apparatus further includes a process setting unit that sets the process execution unit to a state in which a process according to the user instruction received by the first communication unit is executed.

14. The processing apparatus according to claim 2,
wherein the first communication unit receives a user instruction which is set on a side of the mobile device and prescribes processing content in the process execution unit, and
wherein the processing apparatus further includes a process setting unit that sets the process execution unit to a state in which a process according to the user instruction received by the first communication unit is executed.

15. The processing apparatus according to claim 3,
wherein the first communication unit receives a user instruction which is set on a side of the mobile device and prescribes processing content in the process execution unit, and
wherein the processing apparatus further includes a process setting unit that sets the process execution unit to a state in which a process according to the user instruction received by the first communication unit is executed.

16. A mobile device comprising:
a mode switching unit that switches into any one of a plurality of modes including a process request mode which is set and released by a user operation, which is required to check a process request from a user who has authority for at least part of necessary authentication process among executable processes before execution, and which requests a processing apparatus to execute a process according to a user instruction to execute the relevant process;
a second memory that stores a user ID indicative of the user who has the authority to execute the necessary authentication process; and
a second communication unit that performs wireless communication with the processing apparatus in a case where the mobile device is moved to a predetermined communication area with respect to the processing apparatus, and transmits both information that the mobile device is in the process request mode and the user ID stored in the second memory to the processing apparatus through the wireless communication.

17. The mobile device according to claim 16, further comprising:
a process setting unit that sets the user instruction which prescribes processing content supposed to be executed by the processing apparatus according to the user operation,
wherein the second communication unit transmits the user instruction set by the process setting unit to the processing apparatus through the wireless communication with the processing apparatus in a case where the mobile device is moved to the communication area.

18. The mobile device according to claim 16, further comprising:
a device ID setting unit that sets a device ID of the processing apparatus supposed to execute the process according to the user operation,
wherein the second communication unit transmits the device ID set by the device ID setting unit to the processing apparatus through the wireless communication with the processing apparatus in the case where the mobile device is moved to the communication area.

19. The mobile device according to claim 16,
wherein the second communication unit receives a notification of success/failure in the check of the user who has the authority to execute the necessary authentication process, and
wherein the mobile device further includes a notification unit that notifies the notification of success/failure in the check received by the second communication unit to the user.

20. A non-transitory computer readable medium storing an authentication request program causing a mobile device, which includes a built-in information processing apparatus that executes a program, which is required to check a process request from a user who has authority for at least part of necessary authentication process among executable processes before execution, and which performs wireless communication with a processing apparatus in a case where the mobile device is moved to a predetermined communication area with respect to the processing apparatus which executes a process according to a user instruction, to operate as a mobile device comprising:
a mode switching unit that switches into any one of a plurality of modes including a process request mode which is set and released by a user operation, and which requests the processing apparatus to execute a process;
a second memory that stores a user ID indicative of the user who has the authority to execute the necessary authentication process; and
a second communication unit that performs wireless communication with the processing apparatus in a case where the mobile device is moved to the communication area with respect to the processing apparatus, and transmits both information that the mobile device is switched into the process request mode by the mode switching unit and the user ID stored in the second memory to the processing apparatus through the wireless communication.
